(19) United States
(12) Patent Application Publication
(10) Pub. No.: US 2014/0058816 A1
(43) Pub. Date: Feb. 27, 2014

(54) TARGETED COUPON MERCHANDISING METHOD

(71) Applicant: Michael BATT, Ft. Lauderdale, FL (US)

(72) Inventor: Michael BATT, Ft. Lauderdale, FL (US)

(21) Appl. No.: 13/766,275

(22) Filed: Feb. 13, 2013

Related U.S. Application Data
(60) Provisional application No. 61/598,427, filed on Feb. 14, 2012.
(60) Provisional application No. 61/676,400, filed on Jul. 27, 2012.

(51) Int. Cl. G06Q 30/02

(52) U.S. Cl. CPC G06Q 30/0251
USPC 705/14.21; 705/14.1; 705/14.35

(57) ABSTRACT

A method and apparatus for targeted distribution and merchandising, wherein airlines can target travelers with group coupons or vouchers redeemable at a plurality of restaurants in or near the destination city of the traveler.

### RELATED APPLICATIONS

The present application claims priority to, and incorporates by reference thereto, U.S. Provisional Patent Applications Nos. 61/598,427 filed Feb. 14, 2012 and 61/676,400, filed Jul. 27, 2012.

### BACKGROUND

1. Field of the Invention

This invention relates to a method and apparatus for targeted distribution and merchandising of services and/or goods. In particular, the invention relates to a method and apparatus to enable the travel industry, including airlines, hotels, travel agents, travel management companies, and the like, to target travelers with group coupons or vouchers redeemable at a plurality of restaurants in or near the destination city of the traveler. Of course, a person of ordinary skill in the art will understand that the invention is not necessarily so limited.

2. Background of the Invention

Millions of people each day, and hundreds of millions of people each year travel from one city to another. This reflects just the activity in the United States, worldwide the number is significantly larger.

A very high percentage of these travelers make travel arrangements well in advance to take advantage of price discounts, and in view of the fact that travel in general requires advance planning and coordination. Travelers need to make hotel reservations, rental car reservations, and schedule events and meals in their destination cities, or in cities along the travel route that they will be visiting.

It is believed that a very large percentage of travelers book multiple night visits, and are therefore away from home for extended periods of time necessitating many more visits to restaurants, events, and the like.

For example, it is believed that United Airlines alone flies 150 million travelers a year domestically, with an average stay of 3 nights. Of course, this represents incoming and outgoing flights, which means this number represents about 75 million travelers, and conservatively assuming each traveler eats two meals a day at a restaurant over the average 3-day period, this represents approximately 500 million restaurant visits a year. These numbers are only for the domestic operations of one airline.

Of course, the numbers for trips taken by car, train, automobile, boat, and other means of transportation are similarly substantial. These travelers also frequently stay in their destination cities for multiple days, and regularly eat out as well as partake in a variety of other entertainment activities associated with travel.

Accordingly, a need exists for a way to provide travelers, and those that manage and assist travelers, targeted discounts and incentives for the purchase of meals when traveling by from city to city.

### SUMMARY OF THE INVENTION

An object of the present invention is to provide a method to create targeted incentives and discounts for the purchase of meals for travelers in their destination cities.

These and other objects of the present invention will become apparent to those skilled in the art upon reference to the following specification, drawings, and claims. To that end, the present invention provides a targeted discount and incentive program for the purchase of meals when traveling.

### BRIEF DESCRIPTION OF THE FIGURES

FIG. 1 is a screen shot of a home page of a software implementation of the present invention.

FIG. 2 is a screen shot of a particular geographic location application screen.

FIG. 3 is a screen shot of a control panel application screen.

FIG. 4 is a screen shot of a restaurant set up application screen.

### DETAILED DESCRIPTION OF THE PREFERRED EMBODIMENTS

The present invention provides a method and apparatus to offer targeted discounts in the form of coupons or vouchers to travelers, including airline passengers, to use during out of town visits at various participating restaurants, theaters, shops, events, and the like. The invention comprises a voucher or coupon that is universal to a preselected group of merchants located in or near a destination location to be frequented by the traveler purchasing or using the voucher/coupon during some predetermined period of time. The merchants could be restaurants, shops, museums, hotels, entertainment venues, and the like that would be of interest to travelers. The voucher/coupon would be accepted by all of the members of the group, and the traveler would be free to select from among the merchants in the group at the travelers discretion.

In one embodiment of the invention, the invention is applicable to airlines and travel agents and travel management companies, which are in a unique position. Travel management companies are companies that source and manage travel for others, especially for companies with significant travel expenses and budgets. As stated above, not only do these entities book hundreds of millions of travelers a year, they know who the travelers are, where they are going, and how long they are going to stay in a particular destination. This information is available in advance, because it is required information to book a flight.

Additionally, the airlines and travel management companies in many cases know quite a bit more about their travelers than the above information. For example, customer loyalty programs allow for the collection of additional information about customer preferences.

This information can be used to create a program to target incentives, coupons, or vouchers to travelers in an efficient manner. When a traveler books a flight, or shortly thereafter, based on an analysis of the destination city, duration of the visit, and any other preference information known about the traveler, they can be offered an inventive package of discount coupons or vouchers for such things as meals to be used while the traveler is traveling. Similarly, to control costs, a client of a travel management company can direct its employees to use the voucher when traveling on company business.

The package could consist of a coupon that can be redeemed at a group of restaurants in the destination city, or even a single restaurant. The group can consist of any number, but preferably, it is a large enough number to accommodate different tastes in food, price ranges, and settings, but preferably not so large of a group so as to overwhelm the traveler with choices or to prevent the appearance of exclusivity.

The coupons can be purchased in any denominations, or could be given away free in some cases or provided to the traveler at a discount, and would be redeemable at any of the restaurants in the group, making the coupon universal to the group. Preferably, the denomination would be in the range to cover some portion of the cost of the meal, or event, to which it would be applied. For example, common denominations would be in the range of about $5 to $100, more preferably in the range of about $20-$50, and most preferably in the range of about $30. The discount could be up to 100%, and preferably in the range of about 50%. The denomination and discount applied to the coupon can and will vary from these amounts without departing from the scope of the intended invention.

If a traveler did not redeem the coupon on one trip they could use the coupon at a later time on another trip to the same city. The ability to purchase the coupon would not be limited in time, which is a standard feature of prior art couponing systems, and the coupon is also redeemable at any time (subject to reasonable limitations).

The restaurants in the group would all be located in or near the destination city, and can even be clustered based on where the traveler will be staying—if such information is known. The restaurants would include those with a variety of cuisines as well, as those with a variety of price ranges to give the traveler maximum flexibility. The grouping would be large enough to achieve the foregoing diversity, but ideally small enough to still be exclusive. For example, the grouping preferably would represent between about 2% and 10% of the total restaurants in a given area, and more preferably between about 4% and 6%. Of course, this will vary based on the particular geographic area. The size of the grouping can and will vary from these amounts without departing from the scope of the intended invention.

The revenue from the sale of the coupons would be split in some equitable manner between the parties involved, including, the coupon vendor and the restaurant where the traveler redeems the coupon. Revenue will be earned in two stages. For example, in the first stage, the restaurant would receive between about 40% and 60% of the value paid by the traveler for the coupon; most preferably, the restaurant would receive about 50%. This amount is earned by the restaurant once the coupon is redeemed at the restaurant. The participating coupon vendor would receive the remainder of the money paid by the traveler for the coupon. The reimbursement rates can and will vary from these amounts without departing from the scope of the intended invention.

In the second stage, revenue from the program comes from unused coupons. After some period of time, revenue from unredeemed coupons would be shared with participating restaurants either on a pro-rata basis or split evenly between the group in the destination location in which the coupons would have been used.

The present invention can be implemented on, or among, one or more computer systems and/or networked computers. Upon booking a flight, preferably through electronic means, the traveler can then be asked if they want to purchase a coupon in any number of denominations. The package of coupons would be selected based on the destination city, the length of stay, as well as other information if known, such as, the location of the travelers' hotel, the travelers' demographic information (age, income, gender, race, disabilities, mobility, home ownership, employment status, religion, domicile, and the like). The traveler can be queried at the time of purchase for other information that might be useful in determining how to group the coupon package, including information about the nature of the trip (business or pleasure), the number of people traveling with the traveler, food preferences, price preferences, and the like.

This can be accomplished through the airline reservation system, or at a time after booking by providing the traveler with a solicitation by mail, phone, or email. Alternatively, the traveler can obtain the package of coupons on their own through an internet site by establishing an account or providing other indicia of identification sufficient to identify the traveler and the destination. The coupons can also be obtained through clients of travel management companies that direct and administer the travel activities of their employees. This can be accomplished by the traveler through a computing device connected to the internet or other similar computer network, such as a desktop computer, laptop computer, tablet device, cell phone via a downloadable application, and the like.

The implementation of the invention would be accompanied by one or more rules (or exceptions) designed to increase the use and efficiency of the program. Restaurants will have the ability to set a minimum spend during peak periods. Restaurants are typically most busy on weekends, but usually have excess capacity during the week. Ideally, the program would maximize traffic during nonpeak periods, and minimize interruptions to the peak high revenue periods. This can be accomplished with a minimum spend requirement during peak periods whereby anyone using a coupon would need to spend a minimum amount of money in order to use the coupon during the given period. The minimum could be predefined, or determined by the restaurant based on the size of the party, the restaurants demand, its prices, and other factors. This rule would drive traveler traffic to the nonpeak periods, and protect the restaurants profitability when coupons are used during peak periods.

Another rule would be to limit the number of coupons a traveler could use during a given period of time. For example, the traveler might be limited to redeeming no more than two coupons at a given restaurant per week. Of course, the limit can and will vary and could be waived altogether based on particular circumstances. This would avoid having a disproportionate impact falling on any one restaurant in a group, without placing an unreasonable restriction on the travelers' use of the coupons.

Another rule or feature of the invention is that it excludes local participation. This would further protect participating establishments by preventing price erosion in their primary local market. This feature would have the effect of providing a substantial incentive for a new customer base, which would not otherwise be likely to visit the establishment, without eroding the profitability of the dominant local market. This exclusion would be achieved naturally by offering the coupons through the coupon vendor, who only deals with travelers, such as airlines, travel agents, tour operators, travel management companies, and others as described herein. Also, the restriction could be enforced in direct sales to travelers by verifying that the area the coupon covers is a certain distance from where the traveler is located. For example, this can be done by using credit card information to identify the cardholder's location, requiring the traveler to disclose an address, zip code, home state, through the use of geo-location information available from the computing device used by the traveler, or other means.

One embodiment of the present invention includes a software implementation as follows. The implementation consists of a front-end component, which is used by the traveler or a representative of the coupon vendor, and a back-end that supports the front-end.

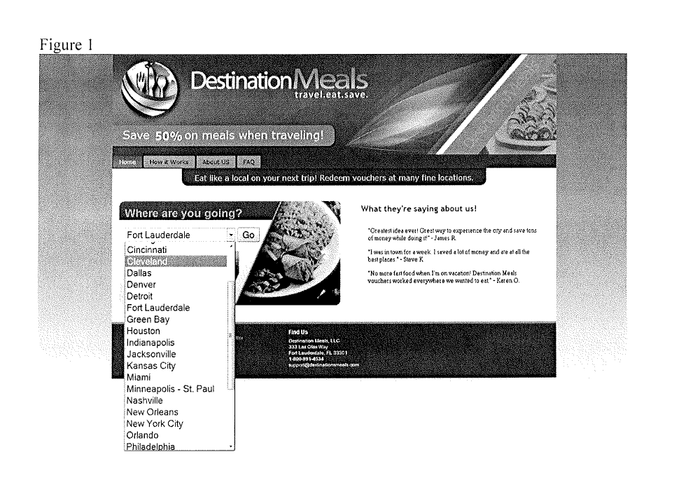

FIG. 1 shows a home page of the software implementation that would be available through an internet site, or on a proprietary network of a coupon vendor. The page includes a number of tabs to select from, and a drop down menu to select the destination area.

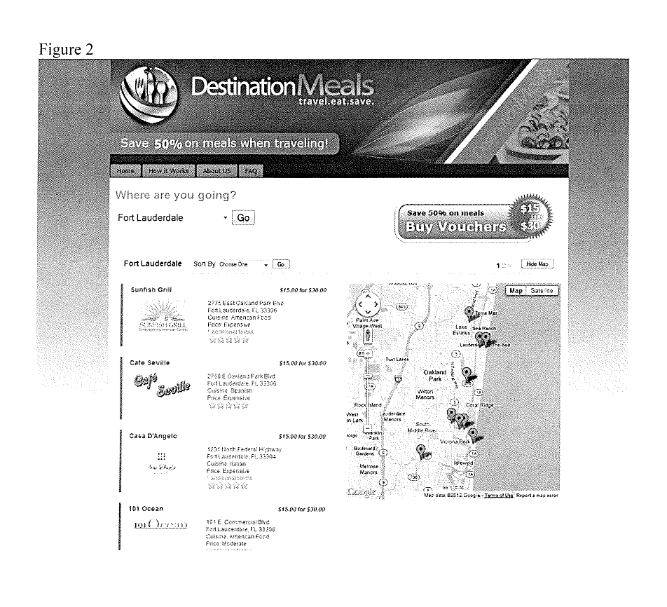

FIG. 2 shows the Fort Lauderdale area screen, by way of example, which displays the restaurants in the coupon group for this area, along with a map of the location of the restaurants. Coupons can then be purchased by selecting the “Buy Vouchers” link, which would then connect to a standard ecommerce shopping cart application. The traveler can then purchase one or more coupons, pay by credit card or the like, and receive the coupons either in electronic form or as a printable voucher, or in any other convenient manner.

Other tabs available in the front-end application include an “About Us” tab, “How it Works” tab, and an “FAQ” tab that all include general information that would be of interest to the traveler in answering any questions they might have or otherwise informing them about the application.

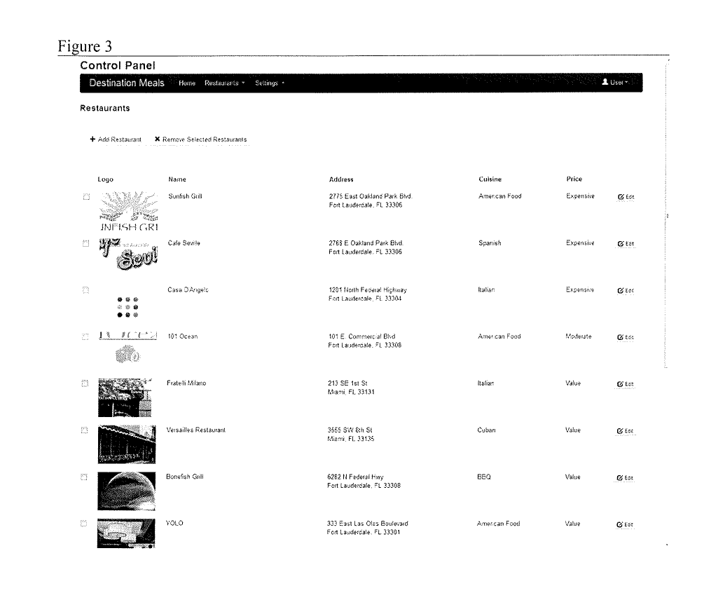

FIG. 3 shows a control panel page used in connection with the back-end of the application. This screen allows for entry of restaurants into the system. Fields are available for logo, name, address (which determines the location that the restaurant is associated with), type of cuisine, and price range. The information about the restaurant can be edited by selecting the edit button. Additionally, restaurants can be added or deleted.

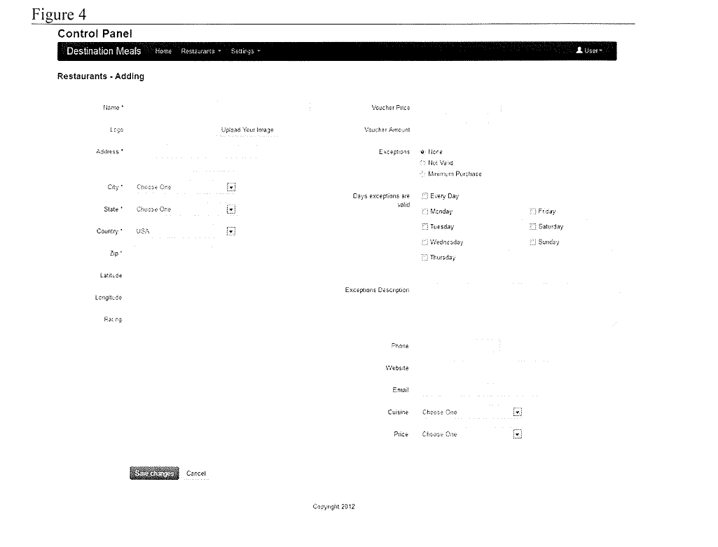

FIG. 4 shows the basic restaurant set up page. The name, location, logo, and other information can be entered or edited on this page. The page also allows for entering the voucher amount and price, which is the value that the voucher will be redeemed at for the restaurant as well as the price the traveler will pay for the voucher. Exceptions can be entered such as if a minimum purchase will apply and what days of the week the exception will apply. The exception can be described in more detail as well.

Additional options include a settings menu that allows for managing a list of geographic locations, and a list of cuisines.

The present invention is not limited to airline travel; the invention can be applied to any mode of transportation including car, boat/ship, automobile, and train. In such cases other entities involved that could serve as coupon vendors include, in addition to airlines, airports, train stations, bus stations, travel management companies, travel agents, online travel agents, tour operators, auto clubs, railways, bus operators, corporate travel buyers, hotels and concierge desks, and any other travel related entities. The traveler in that event can obtain a coupon package from one of the foregoing entities. Or, the traveler can obtain the package directly from a web site offering the packages by establishing an account or providing other indicia of identification sufficient to identify the traveler and the destination.

The present invention while intended to use coupons for redemption at restaurants is not so limited. The invention is applicable to other items and events that might be of interest to travelers, such as hotels, concerts, sporting events, clothing, souvenirs, and the like. Furthermore, the invention in not limited expressly to airlines.

In this manner, the present invention substantially overcomes the limitations of the prior art. The present invention has the advantage of specifically targeting travelers that are likely to be inclined to use the coupons. The travelers will normally be eating in restaurants, and the coupons are targeted specifically to groups of restaurants in the destination city of the travelers. The coupons also have the advantage of being universal in nature, in that they can be redeemed at any restaurant in the group. Typically, a reason for declining to purchase coupons is that coupons are specific to particular establishments and cannot be used anywhere else, and people may not have definite enough plans to know ahead of time what establishments that they will frequent. The present invention targets travelers who are highly likely to be in need of the service offered and allows flexibility in where the coupons will be used.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A method for a defined coupon program targeting travelers, the method being performed by execution of computer readable program code by at least one processor of at least one computer system, the method comprising:
selecting a destination intended for redemption of a coupon;
segregating the coupon to a group of enterprises at which the coupon can be redeemed in or about the destination;
acquiring the coupon in a predetermined denomination; and
redeeming the coupon in or about the destination at one or more of the establishments.

2. The method of claim 1 wherein the coupon is universal to a group of establishments in or about the destination.

3. The method of claim 1 wherein the group consists of restaurants.

4. The method of claim 3 wherein the group is representative of different cuisines and budgets.

5. The method of claim 3 wherein the group is substantially exclusive of establishments in the destination location.

6. The method of claim 1 wherein the redeeming the coupon is associated with one or more rules.

7. The method of claim 6 wherein one or the rules is a minimum spend rule, wherein the coupon can be redeemed only in connection with spending in excess of a predetermined level.

8. The method of claim 7 wherein the minimum spend rule is implemented only during nonpeak hours.

9. The method of claim 6 wherein one of the rules is limits redemption of the coupons within a certain time period.

10. The method of claim 6 wherein one of the rules limits the number of coupons that can be redeemed at any one enterprise within the group.

11. The method of claim 6 wherein one of the rules limits individuals from acquiring the coupon is they are deemed local to the destination.

12. The method of claim 11 wherein local status is based on geographic proximity to the destination.

13. The method of claim 1 wherein the coupons are acquired by person in route to the destination by air.

14. The method of claim 13 wherein the coupons are offered by an airline.

15. The method of claim 1 wherein the coupons are offered by a travel agent.

16. The method of claim 1 wherein the coupons are offered by a travel management company.

17. The method of claim 1 wherein revenue earned from the method is split between an enterprise where the coupon is redeemed and an enterprise that offers the coupon.

18. The method of claim 17 wherein revenue earned from the method includes revenue from unused coupons.
